(19) United States
(12) Patent Application Publication
(10) Pub. No.: US 2007/0183841 A1
(43) Pub. Date: Aug. 9, 2007

(54) Central joint for a steering triangle of moto vehicles

(76) Inventors: Ralf Kunze, Bad Essen (DE); Soren Knopp, Ostercappeln (DE)

Correspondence Address: MCGLEW & TUTTLE, PC, P.O. BOX 9227, SCARBOROUGH STATION, SCARBOROUGH, NY, 10510-9227, US

(21) Appl. No.: 11/570,850

(22) PCT Filed: Jun. 8, 2005
(86) PCT No.: PCT/DE05/01010

§ 371 Date: Dec. 18, 2006

(30) Foreign Application Priority Data
Jun. 18, 2004 (DE) 10 2004 029 581.6

(51) Int. Cl. F16C 11/00

(52) U.S. Cl. 403/131

(57) ABSTRACT

A central joint (1) for a steering triangle of motor vehicles, especially utility vehicles, has a ball pivot (6) accommodated in a joint housing (3), wherein the joint housing (3) is formed from a joint housing body (4) and a joint housing bottom (5) and the ball pivot (6) is formed from a tower-shaped ball pivot body (8) and a joint ball (7) attached to the ball pivot body (8). The ball pivot (6) is mounted in a bearing shell (24) fixed in the joint housing (3) in a pivotingly and rotatingly movable manner. The joint housing (3) is formed from the joint housing body (4) and the joint housing bottom (5) in one piece.

### CROSS REFERENCE TO RELATED APPLICATIONS

This application is a United States National Phase application of International Application PCT/DE 2005/001010 and claims the benefit of priority under 35 U.S.C. § 119 of German Patent Application DE 10 2004 029 581.6 filed Jun. 18, 2004, the entire contents of which are incorporated herein by reference.

### FIELD OF THE INVENTION

The present invention pertains to the mounting of steering triangles for guiding rear axles, especially of utility vehicles, preferably for the central mounting of the steering triangle on the rear axle.

### BACKGROUND OF THE INVENTION

Such steering triangles are used especially to guide rear axles of utility vehicles, wherein two struts, which are connected to the vehicle body in an articulated manner at one end and are connected at their other end to the rear axle of the vehicle by means of a central joint. The two struts are connected via a common joint housing, in which a joint ball, which is rigidly connected to the axle via a ball pivot, is mounted in a pivotingly movable manner.

Such an arrangement is shown, for example, in DE 23 50 087 A1, where a bearing shell is arranged between the joint housing and the joint ball for pivotingly movable mounting. The ball pivot comprises a joint ball with a conical recess, which is in functional connection with a likewise conical surface of a ball pivot body. The joint ball and the ball pivot body are connected here by means of a screw connection, where the screw is led through an offset through hole and meshes with a thread provided in the ball pivot body. Due to the screw connection from the joint ball side, it is necessary to arrange a cover in the joint housing in order to create access to the screw connection. The bottom of the joint housing is thus formed by a separate component. As a result, additional components, for example, additional sealing and connection elements, which increase the assembly effort and the costs and create, moreover, a possible leakage site of the central joint, are disadvantageously necessary.

### SUMMARY OF THE INVENTION

The object of the present invention is therefore to improve a central joint for a steering triangle such that the design and consequently the assembly effort are simplified and, moreover, improved sealing function of the central joint is created.

According to the invention, a central joint is provided for a steering triangle of motor vehicles with a ball pivot mounted in a pivotingly and rotatingly movable manner in a joint housing, wherein the joint housing is formed from a joint housing body and a joint housing bottom and the ball pivot is formed from a tower-shaped ball pivot body and a joint ball attached to the ball pivot body. The joint housing body and the joint housing bottom are made in one piece. As a result, separate components as well as partition lines in the area of the joint housing are avoided, so that the assembly effort can be considerably simplified compared to the state of the art and, moreover, a sealed joint housing can be guaranteed because of the lack of sealing joints. Especially in the case of utility vehicles, the area in which the steering triangle is connected to the axle is increasingly compromised by dirt and moisture, so that the sealing function is of increased significance.

In an advantageous embodiment, the joint ball and the ball pivot body are connected to one another by means of a screw connection, the ball pivot body being cylindrical on its end facing the joint ball and this end being inserted into a likewise cylindrical recess of the joint ball. The diameter of the cylindrical end of the ball pivot body is larger here than the inside diameter of the cylindrical recess of the joint ball, so that there is a uniform surface pressure between the joint ball and the ball pivot body over the area in which they are in contact together, with a slight bracing of the force fit without appreciable stress peaks, as a result of which the permissible operating loads can be considerably increased compared to, for example, a conical force fit. Thus, there also is no notch effect, which could shorten the service life of the tower-shaped ball pivot. Moreover, the joint ball is also expanded uniformly in the radial direction due to the uniform surface pressure, so that no non-uniform bracing can develop in the sliding pair formed by the bearing shell and the joint ball. The bearing shell is rather prestressed uniformly.

The joint ball is fixed against a stop by means of the screw connection, the stop being formed by a surface of the cylindrical end of the tower-shaped ball pivot body, which said surface is, e.g., faced. In conjunction with a stop face within the cylindrical recess of the joint ball, this stop advantageously represents a defined and accurately reproducible indicator of the position of the joint ball in relation to the ball pivot body.

The screw connection is advantageously formed by means of a threaded pin, which passes through a through hole of the ball pivot body, cooperates at one end with a threaded hole in the joint ball and is fixed on the side facing away from the joint ball with a threaded nut in relation to the ball pivot body. The threaded hole in the joint ball advantageously has a shoulder, against which the threaded pin is screwed into the threaded hole, the threaded hole being arranged within a material thickening formed in the bottom of the joint ball, which said material thickening is located within a recess of the cylindrical end of the ball pivot body in the mounted state of the joint ball. The threaded nut is in turn likewise advantageously arranged in the mounted state in a recess, which is located on the side of the ball pivot body facing away from the cylindrical end. For simplified mounting and removal of the central joint, the threaded nut has, moreover, an extended carrying threaded area, which is located within an expanded area of the through hole in a preferred embodiment. This arrangement makes possible a height-adjustable design, because the screw connection is arranged essentially completely within the components to be connected, and, moreover, the joint ball has an increased overlap with the tower-shaped ball pivot body. The extended carrying threaded area advantageously increases, moreover, the load-bearing capacity of the screw connection. Furthermore, in an advantageous manner, there is a full radial overlap of the bearing surface between the bearing shell and the joint ball with the contact surface of the joint ball and the ball pivot body in the axial extension of the bearing shell.

To improve the sliding properties between the bearing shell and the joint ball, a sliding layer, preferably one made of a plastic, may be arranged between the bearing shell and the joint ball.

The bearing shell is advantageously arranged in the joint housing without clearance by means of a retaining ring, which has a conical design on at least one side and meshes with a groove having a conical design on at least one side in the housing.

The present invention will be explained below once again in greater detail on the basis of an exemplary embodiment. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectional view of a central joint for a steering triangle for a motor vehicle.

### DESCRIPTION OF THE PREFERRED EMBODIMENTS

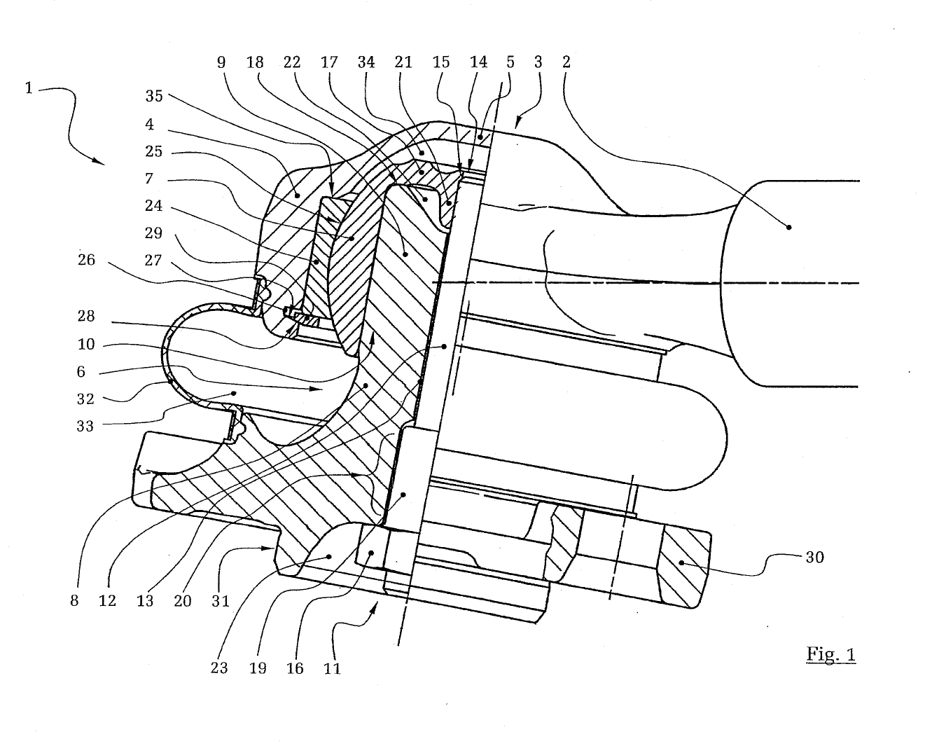

Referring to the drawings in particular, FIG. 1 shows a sectional view of a central joint 1 of a steering triangle, which connects two struts 2 (only one strut being shown here) to one another via a joint housing 3. The joint housing 3, built up from a joint housing body 4 and a joint housing bottom 5, is made in one piece, for example, from a metallic cast material. A ball pivot 6 is arranged in a rotatingly and pivotingly movable manner in the joint housing 3, the ball pivot 6 having ajoint ball 7 and a ball pivot body 8. The ball pivot body 8 has a cylindrical end 9, which is inserted into a likewise cylindrical recess 10 of the joint ball 7. The cylindrical end 9 of the joint ball body 8 has a larger diameter than the cylindrical recess 10 of the joint ball 7, so that there is a press fit between the joint ball 7 and the ball pivot body 8. Instead of the cylindrical shape of the recess 10 and of the end 9 of the ball pivot body 8, it is also possible to select any other positive-locking connection, for example, a polygonal (hexagonal, octagonal, etc.) or another polygonal positive-locking connection.

The joint ball 7 and the ball pivot body 8 are connected to one another by means of a screw connection 11. The screw connection 11 is formed from a threaded pin 12, which passes through a through hole 13 of the ball pivot body 8 and is screwed into a through hole 14 in the joint ball 7 up to a stop 15 within the threaded hole 14, as well as a threaded nut 16, which is screwed onto the threaded pin 12 on the side of the ball pivot body 8 facing away from the joint ball 7 and is screwed against the ball pivot body 8. The joint ball 7 is thus attached to the ball pivot body 8, specifically such that the joint ball 7 with its joint ball bottom 17 comes to lie against a, for example, faced front surface 18 of the cylindrical end of the ball pivot body 8. An always reproducible and highly accurately determinable mounting indicator is thus obtained.

The threaded nut 16 has an extended carrying threaded area 19, which is arranged in an area 20 with increased diameter of the through hole 13 in the mounted state.

The threaded hole 14 is arranged within a material thickening 21 of the joint ball bottom 17, the material thickening 21 itself being arranged within a recess 22 of the ball pivot body 8 in the mounted state. The threaded nut 16 is arranged in the mounted state in another recess 23 of the ball pivot body 8, which said recess is arranged on the side of the ball pivot body 8 facing away from the recess 22. Since the threaded pin 12 is not longer than the structure of the ball pivot body 8 and the joint ball 7, the entire screw connection 11 is arranged within the ball pivot 6, whereby a very compact design is obtained on the whole.

A bearing shell 24, which preferably consists of a metallic material in this exemplary embodiment, is arranged between the joint ball and the joint housing body 4. To improve the sliding properties, an additional sliding layer 25, preferably one consisting of a plastic, which acts between the bearing shell 24 and the joint ball 7, is provided on the bearing shell 24. The bearing shell 24 is held in the joint housing 3 by means of a wedge-shaped retaining ring 26. The retaining ring 26 meshes with a groove 27 and has a conical outer surface 28, which faces away from the bearing shell 24 and cooperates with a likewise conically shaped inner wall 29 of the groove 27, so that the bearing shell 24 is held in the joint housing 3 without clearance.

The ball pivot body 8 has an inner flange 30, at which a centering attachment 31 is, furthermore, arranged for accurate positioning of the central joint 1 at the axis. Moreover, a sealing bellows 32 is provided between the flange 30 and the joint housing 3. The space 33 enclosed by the sealing bellows 32 as well as the space 34 left between the joint ball bottom 17 and the joint housing bottom 5 may be filled with a lubricant.

Since the cylindrical end 9 of the ball pivot body 8 protrudes very far into the recess 10 of the joint ball 7, namely, up to the joint ball bottom 17, there is an axial overlap of the active surface or the friction surface between the bearing shell 24 and the joint ball 7 with the contact surface between the joint ball 7 and the cylindrical end 9 of the ball pivot body 8. This contributes to improved transmission of the forces acting between the joint housing 3 and the ball pivot 6. In addition, the joint ball 7 expands radially uniformly due to this shape of the connection between the joint ball 7 and the ball pivot body 8, e.g., due to a force fit that is uniform over the axial extension of the cylindrical connection, so that the prestress between the bearing shell 24 and the joint ball 25 is also distributed uniformly over the surface of the bearing shell 24.

In a first step, the sliding layer 25 is applied, for example, bonded to the bearing shell 24. The bearing shell 24, thus prefabricated, is subsequently pulled over the joint ball 7 and pressed against the joint ball 7, so that the bearing shell 24 is in contact with the joint ball 7. The bearing shell 24 is thus made integrally in one piece with the joint ball 7. However, this making integrally in one piece may also be carried out, for example, only when the bearing shell 24 is inserted into the joint housing 3 together with the joint ball 7. In a next step, a heat treatment is carried out, and the sliding layer 25, which consists of a plastic in this exemplary embodiment, is “baked,” i.e., the sliding layer 25 attains its final strength, friction and wear properties at certain temperatures as a function of the time and pressure parameters.

The unit thus prefabricated, comprising the joint ball 7 and the bearing shell 24, is now pressed into the joint housing 3 until it comes into contact with a housing shoulder 35. The bearing shell 24 is subsequently fixed in the joint housing without clearance by mans of the wedge-shaped retaining ring 26 inserted into the groove 27. The threaded pin 12 is then screwed into the threaded hole 14 up to the stop 15, which is formed, for example, by a deformation ofthe threads, and the sealing bellows 32 is fastened to the joint housing 3 in a another step, possibly with additional auxiliary means, for example, retaining rings or clamps, which are not shown here more specifically.

Furthermore, the ball pivot body 8 is then attached to the threaded pin 12. The threaded nut 16 is now screwed onto the threaded pin 12 until it comes into contact with the ball pivot bottom 8. This step may be carried out, for example, manually. When the threaded nut 16 is screwed onto the threaded pin 12, the extended threaded area 19 ofthe threaded nut 16 is first screwed over the threaded pin 12 by a few threads. The threaded pin 12 is still completely in the through hole 13 when the ball pivot body 8 is only brought into contact with the joint ball 7, and only the end of the threaded pin 12 facing the threaded nut 16 comes to lie in the increased-diameter area 20 of the through hole 13, so that the threaded nut 16 can grasp the threaded pin 12. The threaded nut 10 is now turned further by means of a tool, so that the ball pivot body 8 is pulled into the recess 10 of the joint ball 7 to the extent that the front surface 18 of the ball pivot body 8 comes into contact with the joint ball bottom 17. The threaded nut 16 is tightened here according to a preset torque. The sealing bellows 32 is finally fastened to the flange 30 of the ball pivot body 8 with, e.g., a clamp (not shown in more detail), and the central joint 1 is optionally filled with a lubricant.

Due to the extended threaded area 19 of the threaded nut 16, which is arranged within the ball pivot body 8 in the mounted state, the threaded pin 12 may be made very short. It is possible, as a result, to keep the overall height of the central joint 1 small and to design of the central joint 1 as a whole as a very compact central joint.

The central joint 1 thus manufactured forms, together with the struts 8, one assembly unit, which can be mounted on an axis via the centering attachment 31.

The sequence of mounting described here expressly represents only one possible sequence of the steps for manufacturing the central joint 1. Mounting sequences that differ from this are, of course, conceivable and also feasible.

Due to the one-piece design of the joint housing 3, no sealing problems develop in the area of the joint housing bottom 5 against the joint housing body 4, because there are no sealing joints in this area. Furthermore, additional components, for example, connection elements such as screws or rivets and sealing rings, may be completely elminated. The design ofthe joint housing 3 as a casting, which is shown in the exemplary embodiment, represents only one possible variant of the one-piece design. Besides, it is, of course, also conceivable to connect the joint housing bottom 5 to the joint housing body 4 by means of a weld seam or to manufacture the joint housing 3 in one piece by machining or to form it as a forged housing.

While specific embodiments of the invention have been shown and described in detail to illustrate the application of the principles of the invention, it will be understood that the invention may be embodied otherwise without departing from such principles.

1. A central joint for a steering triangle of motor vehicles, the central joint comprising:
a joint housing;
a bearing shell;
a ball pivot accommodated in said joint housing wherein:
said joint housing comprises a joint housing body and a joint housing bottom and
said ball pivot is formed from a tower-shaped ball pivot body and a joint ball attached to said ball pivot body, and
said ball pivot is mounted in said bearing shell and is fixed in said joint housing in a pivotingly and rotatingly movable manner, said joint housing being formed from said joint housing body and said joint housing bottom in one piece.

2. A central joint for a steering triangle in accordance with claim 1, wherein said joint ball is connected to said ball pivot body by means of a screw connection.

3. A central joint for a steering triangle in accordance with claim 1, wherein said ball pivot body has a cylindrical shape at end thereof, said end facing said joint ball, wherein said end is inserted into a, likewise cylindrically shaped recess of said joint ball.

4. A central joint for a steering triangle in accordance with claim 1, wherein said ball pivot body and said joint ball are in functional connection with one another via a positive-locking connection, with a serration profile, a polygon profile or another polygon profile.

5. A central joint for a steering triangle in accordance with claim 3, wherein said cylindrical end of said ball pivot body forms a stop with a front surface for accommodating said joint ball.

6. A central joint for a steering triangle in accordance with claim 3, wherein a diameter of said cylindrical end of said ball pivot body is larger than an internal diameter of said cylindrical recess of said joint ball.

7. A central joint for a steering triangle in accordance with claim 3, wherein a press fit acts between said ball pivot body and said joint ball.

8. A central joint for a steering triangle in accordance with claim 2, wherein said screw connection is formed by a threaded pin, which passes through a through hole of said ball pivot body, cooperates at one end with a threaded hole in said joint ball and is fixed with a threaded nut against said ball pivot body on a side of said ball pivot body facing away from said joint ball.

9. A central joint for a steering triangle in accordance with claim 8, wherein said threaded hole in said joint ball has a stop, against which said threaded pin is screwed into said threaded hole.

10. A central joint for a steering triangle in accordance with claim 8, wherein said threaded hole is arranged in an area of a material thickening of ajoint ball bottom of said joint ball, wherein said ball pivot body has, at a cylindrical end thereof, a recess, within which said material thickening is arranged in a mounted state.

11. A central joint for a steering triangle in accordance with claim 8, characterized in that wherein said threaded nut has a extended threaded area.

12. A central joint for a steering triangle in accordance with claim 8, wherein said threaded nut is arranged essentially within a recess of said ball pivot body in a mounted state.

13. A central joint for a steering triangle in accordance with claim 2, wherein said extended carrying threaded area of said threaded nut is arranged within an increased-diameter area of said through hole in the mounted state.

14. A central joint for a steering triangle in accordance with claim 1, wherein said ball pivot has a flange with a centering attachment at its end facing away from said joint ball.

15. A central joint for a steering triangle in accordance with claim 1, wherein a sliding layer, preferably made of a plastic, is arranged between said bearing shell and said joint ball.

16. A central joint for a steering triangle in accordance with claim 1, further comprising: a retaining ring, wherein said bearing shell is arranged in said joint housing without clearance by means of said retaining ring, which is formed with at least one outer surface having a conical shape on one side and which meshes with an inner wall in said joint housing, which said inner wall is conical at least on one side.

17. A of motor vehicle steering triangle central joint comprising:
an annular joint housing body integral with a joint housing bottom to form a single piece joint housing;
a bearing shell disposed in said joint housing;
a ball pivot accommodated in said joint housing, said ball pivot comprising an elongate ball pivot body and a joint ball attached to said ball pivot body, said ball pivot being mounted in said bearing shell and being fixed in said joint housing in a pivotingly and rotatingly movable manner.

18. A central joint in accordance with claim 17, wherein said joint ball is connected to said ball pivot body by means of a screw connection.

19. A central joint for a steering triangle in accordance with claim 17, wherein said ball pivot body and said joint ball are in functional connection with one another via a positive-locking connection.

20. A central joint for a steering triangle in accordance with claim 17, further comprising:
a retaining ring, wherein said bearing shell is arranged in said joint housing without clearance by means of said retaining ring, said retaining ring having at least one outer surface with a conical shape on one side and which meshes with an inner wall defined in said joint housing, said inner wall being conical at least on one side.
